(19) United States
(12) Patent Application Publication
(10) Pub. No.: US 2007/0119818 A1
(43) Pub. Date: May 31, 2007

(54) Compressed-gas-insulated switch-disconnector module and bushing configuration

(75) Inventor: Manfred Meinherz, Berlin (DE)

Correspondence Address: LERNER GREENBERG STEMER LLP, P O BOX 2480, HOLLYWOOD, FL, 33022-2480, US

(73) Assignee: Siemens Akiengesellschaft

(21) Appl. No.: 10/587,698

(22) PCT Filed: Jan. 28, 2005
(86) PCT No.: PCT/DE05/00160

§ 371 Date: Jul. 27, 2006

(30) Foreign Application Priority Data
Jan. 30, 2004 (DE) 10 2004 006 045.2

(51) Int. Cl. H01H 33/12

(52) U.S. Cl. 218/13

(57) ABSTRACT

A bushing configuration includes a switch disconnector connected to an electrically insulating casing in the form of an outdoor bushing. A tubular electrode is disposed in a region of a flange of the electrically insulating casing and the switch disconnector and projects over the flange. A common gas area is formed by the electrically insulating casing and a housing of the switch disconnector.

### DESCRIPTION

Compressed-gas-insulated switch-disconnector module and bushing arrangement

The invention relates to a compressed-gas-insulated switch-disconnector module having an electrically conductive housing and having a main axis along which in each case one first and one second electrical conductor which are connected to an isolating gap extend.

A switch-disconnector module such as this is known, for example, from U.S. Pat. No. 6,538,224 B2. In the known arrangement, an interrupter unit of a circuit breaker is arranged within a grounded encapsulating housing. Flanges are arranged on the encapsulating housing, through which electrical conductors are passed in order to make contact with the interrupter unit. A switch-disconnector module is flange-connected to each of the flanges. The electrical conductors which are supplied can be electrically isolated from the interrupter unit by means of the switch-disconnector modules. The switch-disconnector modules are bounded by means of partition insulators from adjacent compressed-gas-insulated areas of the encapsulating housing of the circuit breaker and from adjacent outdoor bushings. Since the outdoor bushings are no longer directly flange-connected to the encapsulating housing, the position of the outdoor connections changes over the length of the switch-disconnector modules.

A circuit breaker which is equipped with switch-disconnector modules such as this can, for example, no longer be used in standardized switch panels.

The present invention is based on the object of designing a compressed-gas-insulated switch-disconnector module of the type mentioned in the introduction such that it has a short physical length.

In the case of a compressed-gas-insulated switch-disconnector module of the type mentioned in the introduction according to the invention, the object is achieved in that the first phase conductor passes through a first flange on the switch-disconnector housing, and the second phase conductor passes through a second flange on the switch-disconnector housing. A tubular electrode is connected to the housing of the switch-disconnector module, concentrically surrounds the first phase conductor, is arranged radially on the inside of the first flange, and projects beyond it.

The flange surfaces of the first flange are dielectrically shielded by means of the tubular electrode. It is thus possible to arrange the housing of the switch-disconnector module in a small volume directly around the isolating gap of the switch disconnector. This shortens the isolating gaps which govern the physical size.

A further advantageous refinement can provide that the second flange, which is arranged coaxially with respect to the first flange at the opposite end of the housing, has a holding device, onto which a toroidal transformer can be fitted, on its outside.

The coaxial arrangement of the first and second flanges results in the switch-disconnector module having an elongated shape. All of the apparatuses which are required to form the switch-disconnector module can extend along the main axis. In addition to the flange function of the second flange, this may also have a holding apparatus for a toroidal transformer on its outside. This provides the capability to complete the switch-disconnector module as a subassembly.

In this case, it is advantageously possible to provide for the second flange to be arranged at the end of a tubular connecting stub which at least partially supports the transformer.

The physical height of the switch-disconnector module can be reduced by a combination of the second flange with a tubular connecting stub. The transformers which are alternatively fitted to intermediate housings or to a mating flange are now associated with the switch-disconnector module. This makes it possible to reduce the number of flange connections required. This reduction allows the overall physical length of the switch-disconnector module to be reduced.

It is advantageously also possible to provide for the first and the second flange to be annular, and for the first flange to have a larger circumference than the second flange.

If the circumference of the second flange is smaller than that of the first flange, a toroidal transformer can be pushed onto the second flange without any problems. Its external contour corresponds approximately to the contour of the first flange. This results in the overall structure of the switch-disconnector module having an approximately cylindrical external contour. Individual projecting assemblies are thus avoided. At the same time, sufficient space is available in the area of the first flange to shape the tubular electrode in a suitable manner.

A further advantageous refinement makes it possible to provide for the electrode to be supported by the housing, in particular being cast onto it.

In order to ensure that the housing has adequate pressure resistance, it must be manufactured from a mechanically robust material, for example aluminum. At the same time, the housing forms a framework for all of the assemblies which are attached to it or installed in it, such as the isolating gap and the transformer. Mechanical forces are introduced into the housing structure via the first and the second flange. Casting the electrode onto the housing allows particularly effective manufacturing methods to be used to produce the housing. For example this can thus be manufactured as an integral casting. It is thus also possible to produce embodiments of the housing with fine elements.

A further advantageous refinement makes it possible to provide for one of the phase conductors to have the capability to be grounded by means of a grounding switch in the interior of the housing.

A compressed gas is applied to the interior that is surrounded by the housing. This area is therefore not mechanically accessible from the outside. If a grounding switch operates incorrectly, fault arcs occur, which could adversely affect the health of the operator. It is virtually impossible for a fault arc to emerge from the interior of the housing. This makes it possible to virtually preclude any hazard to the operator, particularly in the case of manually operated grounding switches. It is also possible to provide a plurality of grounding switches in order, for example, to ground a first and a second phase conductor.

In the prior art described in the introduction, outdoor bushings are provided in order to connect the electrical lines to the interrupter unit in the circuit breaker. The conventional design of the known switch-disconnector module makes it necessary to insert the switch-disconnector module between an outdoor bushing and a connecting flange of the encapsulating housing of the circuit breaker.

A further object of the invention is therefore to specify a bushing arrangement which has a switch disconnector with an isolating gap which has a compact physical shape.

In the case of a bushing arrangement having a switch-disconnector with an isolating gap which is arranged such that it is insulated by means of compressed gas within an electrically conductive housing, the object is achieved according to the invention in that a first phase conductor which is passed through an electrically insulating casing that is flange-connected to the housing passes through the casing in the form of an outdoor bushing and is connected at one of its ends to a switching contact of the isolating gap, with the housing and the casing surrounding a common gas area.

The common gas area means that there is no need to use partition insulators. These partition insulators increase the physical volume of a bushing arrangement with the switch disconnector by the physical height of each of the flanges that are required and of the insulating partitions. The connection of a switching contact of the isolating gap to the first phase conductor allows the isolating gap and the first phase conductor to be made adequately mutually mechanically robust. The first phase conductor may, for example, be held on the insulating casing in the area in which it passes through the wall of the casing. The common gas area also makes it possible for the assemblies to jointly use sections of the electrically conductive housing. Strict separation and splitting into individual gas areas would make such flexible usage of the space in the housing more difficult.

It is also advantageously possible to provide for the first phase conductor to be supported on the housing by means of a pillar support.

Depending on the configuration of the isolating gap and of the phase conductor, the supporting pillar can be arranged very flexibly in the interior of the housing. In this case, it is possible to provide for the pillar support to be arranged directly on the first phase conductor, or it is also advantageously possible to provide for the first phase conductor to be supported via a switching contact of the switch disconnector.

The joint use of pillar supports in the interior of the housing makes it possible to reduce the number of pillar supports themselves. This in turn results in space areas in the interior of the housing, which can be filled with further assemblies, for example with conductor runs, switching contacts or else grounding contacts.

It is advantageously also possible to provide for the gas area to extend into a tubular connecting stub of the housing, around which a toroidal transformer is arranged.

The filling of a tubular connecting stub with the compressed gas from the gas area also allows the dielectric strength of this area to be increased. The compressed-gas filling makes it possible to reduce the circumference of the tubular connecting stub. This makes it possible to push conventional toroidal transformers with standardized openings onto the tubular connecting stub of the housing.

It is advantageously also possible to provide for an electrode to extend coaxially with respect to the first phase conductor, and for the electrode to shield the connecting area between the insulating casing and the housing.

The use of the electrode allows a junction area from the grounded housing to the insulating casing to be shortened. In this case, the electrical fields are influenced by the electrode in such a way that the connecting area between the electrically insulating casing and the housing of the first flange is not subject to unacceptable electrical loading.

The invention will be described in more detail in the following text with reference to one exemplary embodiment, and is illustrated schematically in a drawing, in which:

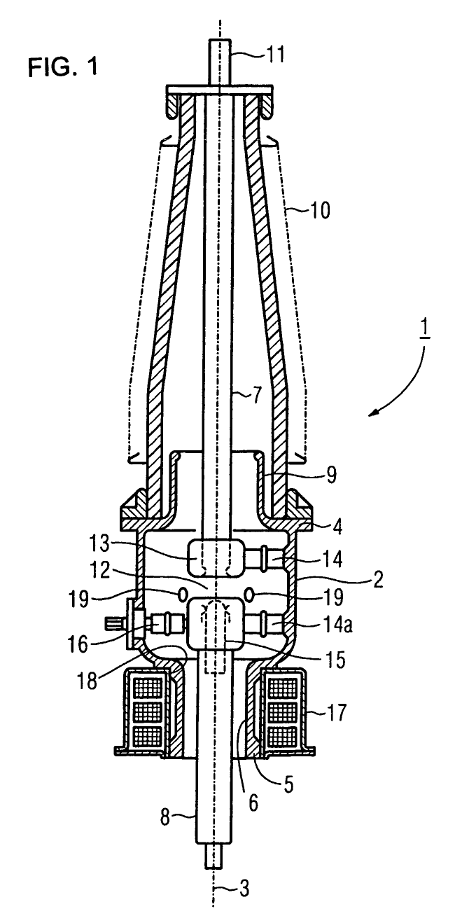

FIG. 1 shows a first embodiment variant of a bushing arrangement as well as a switch-disconnector module,

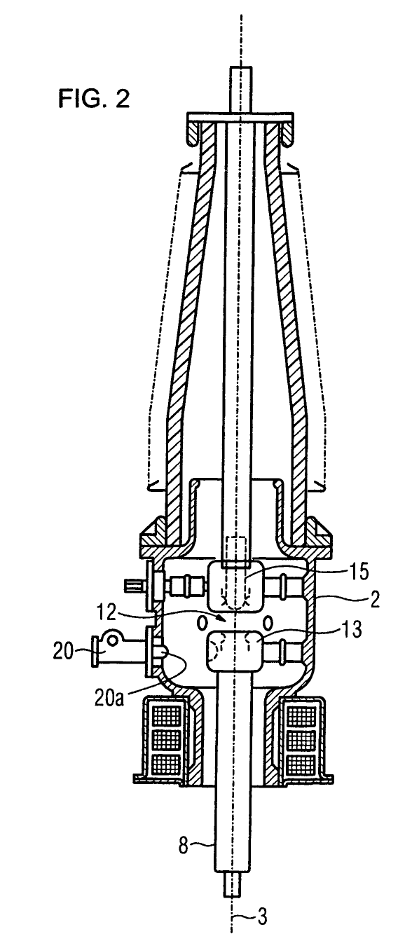

FIG. 2 shows a second embodiment variant of a bushing arrangement with a switch-disconnector module,

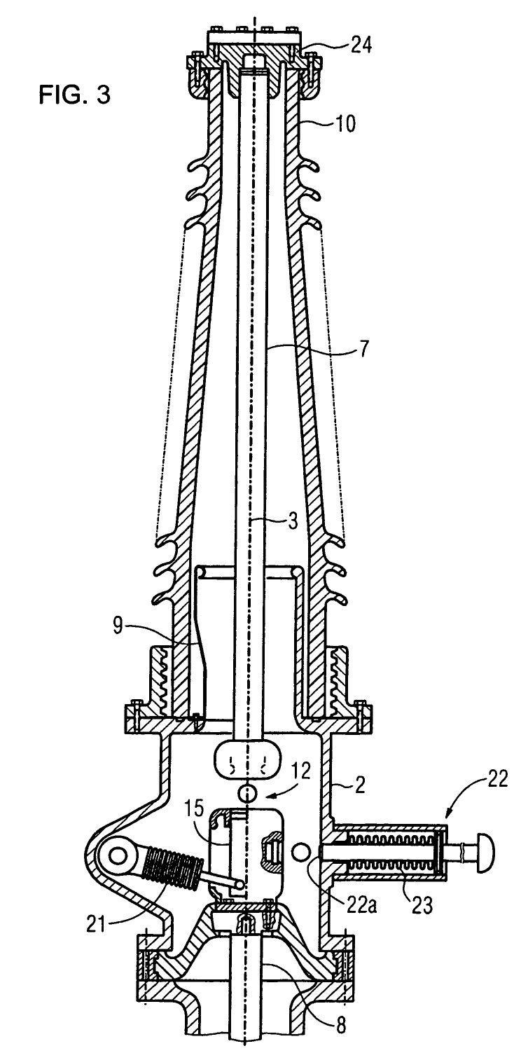

FIG. 3 shows a third embodiment variant of a bushing arrangement with a switch-disconnector module,

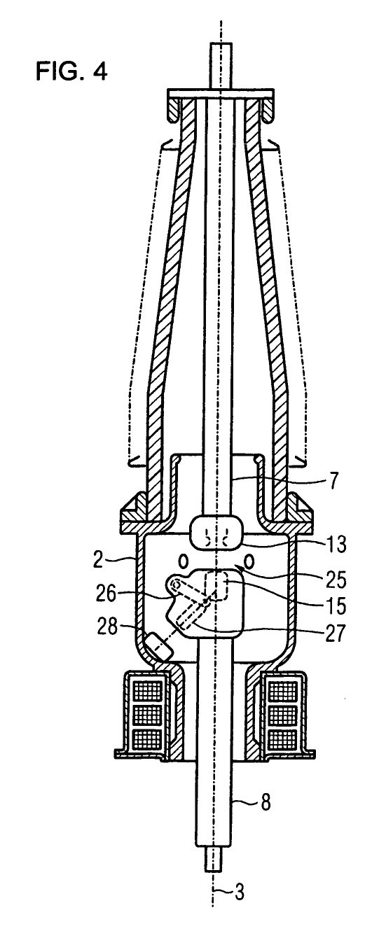

FIG. 4 shows a fourth embodiment variant of a bushing arrangement with a switch-disconnector module,

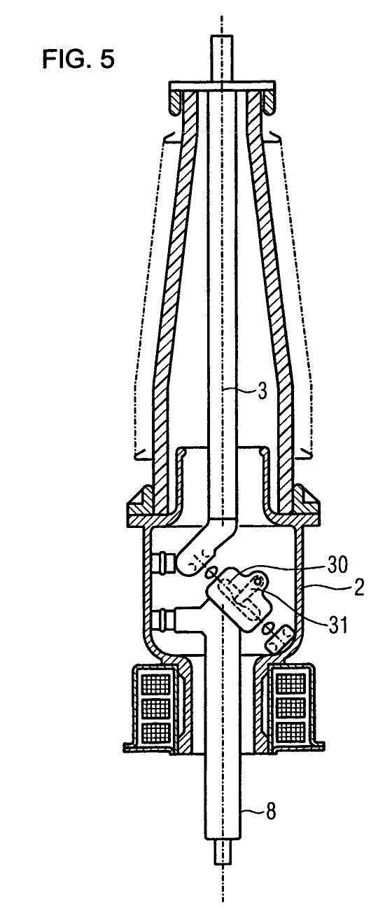

FIG. 5 shows a fifth embodiment variant of a bushing arrangement with a switch-disconnector module, and

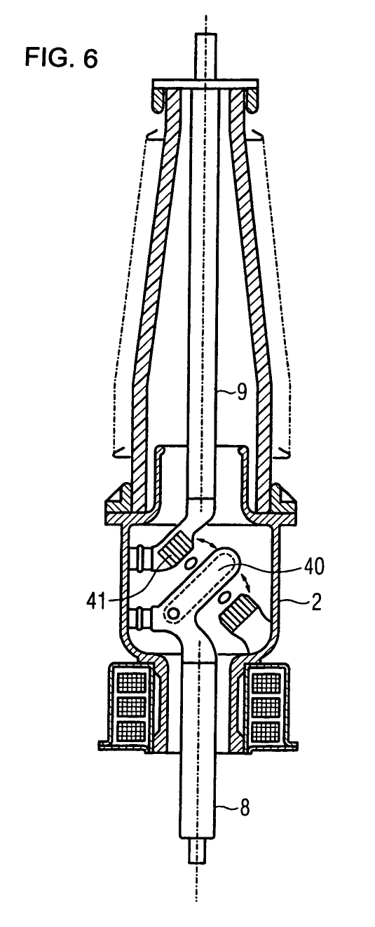

FIG. 6 shows a sixth embodiment variant of a bushing arrangement with a switch-disconnector module.

FIG. 1 shows a first variant of a bushing arrangement 1. The bushing arrangement 1 has a compressed-gas-insulated switch-disconnector housing 2. The switch-disconnector housing 2 is arranged to be essentially rotationally symmetrical around a main axis 3. A first flange 4 is arranged on the switch-disconnector housing 2, coaxially with respect to the main axis 3. A second flange 5 is arranged on the switch-disconnector housing 2, likewise coaxially with respect to the main axis 3, in the direction facing away from the first flange 4. The second flange 5 is arranged at the end of a tubular connecting stub 6 on the switch-disconnector housing 2. A first electrical phase conductor 7 and a second electrical phase conductor 8 are also arranged along the main axis 3. The first electrical phase conductor 7 is inserted into the interior of the switch-disconnector housing 2 through the first flange 4. The second electrical phase conductor 8 is inserted into the interior of the switch-disconnector housing 2 through the second flange 5. The two electrical phase conductors 7, 8 are arranged coaxially with respect to one another.

A tubular electrode 9 is arranged on the switch-disconnector housing 2 internally and radially on the first flange 4. The tubular electrode 9 surrounds the first electrical phase conductor 7. An electrically insulating casing 10 is flange-connected to the first flange 4. The electrically insulating casing 10 is in the form of an outdoor bushing, in a known manner. The casing 10 may, for example, be manufactured from a porcelain or from a plastic. The electrically insulating casing 10 is a rotationally symmetrical hollow body which is arranged coaxially with respect to the main axis 3. The first electrical phase conductor 7 passes through the free end of the electrically insulating casing 10. Outside the electrically insulating casing 10, the first phase conductor 7 forms a first connecting point 11. By way of example, an overhead line may be electrically conductively connected to the first connecting point 11.

The tubular electrode 9 is integrally connected to the switch-disconnector housing 2 and is cast on in a casting process during the manufacture of the switch-disconnector housing 2.

An isolating gap 12 is arranged in the interior of the switch-disconnector housing 2. The isolating gap 12 has a first switching contact 13 which is mounted on the switch-disconnector housing 2 in a fixed position by means of a supporting insulator 14. The isolating gap 12 also has a movable switching contact 15. The movable switching contact 15 is in the form of a bolt. A rotary movement can be transmitted via an electrically insulating shaft 16 from outside the switch-disconnector housing 2 into the interior of the switch-disconnector housing 2.

A pinion is arranged on the electrically insulating shaft 16 and is operatively connected to a tooth system arranged on the movable isolating contact 15. The movable isolating contact 15 is moved when the electrically insulating shaft 16 carries out a corresponding rotary movement. When the isolating gap 12 is in the open state, the movable isolating contact 15 has been pulled into a recess in the second electrical phase conductor 8. The movable isolating contact 15 is mounted on the second electrical phase conductor 8. The second electrical phase conductor 8 and the movable isolating contact 15 are supported by means of a further supporting insulator 14a.

In order to monitor an electric current which flows through the first and second electrical phase conductors 7, 8, respectively, the second flange 5 is provided with a holding apparatus onto which a toroidal current transformer 17 can be pushed. For this purpose, the second flange 5 has a cylindrical external circumference. The toroidal transformer can now touch the cylindrical outer surface formed in this way, at least in places. A further outer surface 18 with a cylindrical circumference is also integrally formed on the tubular connecting stub 6. The toroidal current transformer 17 is additionally mounted on this outer surface 18 with a cylindrical circumference. The outer surface 18 with the cylindrical circumference is immediately adjacent to a projection on the compressed-gas-insulated switch-disconnector housing 2, thus forming a stop which limits the extent to which the toroidal current transformer can be pushed onto the tubular connecting stub 6. The wall thickness of the tubular connecting stub 6 is reduced between the outer surface 18, which has a cylindrical circumference, and the second flange 5, thus forming a circumferential recess. This recess makes it easier to push the toroidal current transformer 17 on. Furthermore, this area is available for circulation of a cooling medium. The bushing arrangement can be connected by means of the second connecting stub 5 to a second encapsulating housing, for example an encapsulating housing of a high-voltage circuit breaker.

Furthermore, the switch-disconnector housing 2 has optically transparent but gas-tight observation openings 19. The observation openings 19 allow the isolating gap 12 to be viewed from outside the compressed-gas-insulated switch-disconnector housing 2.

The volume which is formed by the compressed-gas-insulated switch-disconnector housing 2 and the electrically insulating casing 10 as well as the tubular connecting stub 6 represents a common gas area. This gas area is filled with an insulating gas at an increased pressure, for example sulfurhexafluoride. It is possible for the insulating gas to circulate on the basis of convection, for example from the tubular connecting stub 6 through the switch-disconnector housing 2 into the area of the free end of the electrically insulating casing 10.

FIG. 2 illustrates one embodiment variant of a bushing arrangement. In principle, this corresponds to the variant illustrated in FIG. 1. Only the specific refinements will therefore now be indicated. Assemblies having the same effect are provided with the same reference signs as in FIG. 1. The compressed-gas-insulated switch-disconnector housing 2 is additionally provided with a grounding switch 20. The grounding switch 20 has a grounding contact 20a, which makes permanent contact with the electrically conductive switch-disconnector housing 2, which is at ground potential. This grounding contact 20a is moved radially with respect to the main axis 3. A mating contact is associated with the grounding contact 20a on the fixed-position switching contact 13 (which in the present exemplary embodiment is attached to the second electrical phase conductor 8). The electrical phase conductor 8 can be grounded via this mating contact and the fixed-position switching contact 13. In comparison to the variant illustrated in FIG. 1, the installation locations of the fixed-position switching contact 13 and of the movable switching contact 15 have been interchanged for the isolating gap 12.

The third embodiment variant of a bushing arrangement as illustrated in FIG. 3 shows an alternative embodiment of the drive for the movable contact piece 15 for the isolating gap 12. The movable isolating contact 15 can be moved by means of a rocker 21, which is mounted such that it can pivot. A manually operable grounding switch 22, which is arranged on the compressed-gas-insulated switch-disconnector housing 2, is also illustrated, in the form of a section. A grounding contact 22a is sealed from the switch-disconnector housing 2 by means of a bellows 23. The grounding contact 22a can be moved into a mating contact with the bellows 23 being deformed, and with its mating contact being electrically conductively connected to the movable isolating contact 15 and to the second electrical phase conductor 8.

Furthermore, FIG. 3 shows an alternative embodiment of the tubular electrode 9. Divided by the main axis 3, the illustration shows on the one hand an embodiment of the tubular electrode 9 in the form of a sheet-metal body, which can be screwed to the switch-disconnector housing 2 by means of screw connections. Alternatively, an embodiment of the tubular electrode 9 in the form of casting is also illustrated. The way in which the first phase conductor 7 is passed through the electrically insulating casing 10 by means of a fitting body 24 can also be seen, in the form of a section. The use of a fitting body 24 makes it easier to seal the electrically insulating casing in the area in which the first phase conductor passes through it, since the first electrical phase conductor 7 is inserted into the fitting body 24. This avoids the need for an interface, which additionally needs to be sealed, in the area in which the first electrical phase conductor 7 passes through the electrically insulating casing 10.

FIGS. 4, 5 and 6 each show embodiment variants which are based on a development of the embodiment variant of a bushing arrangement as illustrated in FIG. 1. The basic design of the bushing arrangements illustrated in FIGS. 4, 5 and 6 in each case corresponds to that of the first embodiment variant illustrated in FIG. 1. The only difference is that different variants are shown in the form of the isolating gap in the switch disconnector, and an associated grounding device. The following text will therefore describe only the respective embodiments of the isolating gap and grounding apparatus.

The isolating gap 25 illustrated in FIG. 4 has a stationary switching contact 13 as well as a movable switching contact 15. The movable switching contact 15 can be moved via a rocker 26. Furthermore, a grounding contact 27 can be moved via the rocker 26. During an opening movement of the isolating gap, and during a movement associated with this of the movable switching contact 15, the rocker 26 is moved further after the movable switching contact 15 reaches the switched-off position, as a result of which a grounding contact 27 can be moved into a mating contact 28 which is arranged on the switch-disconnector housing 2. The second electrical phase conductor 8 can be grounded by the further movement of the rocker 26. The grounding contact 27 is in this case moved at an angle to the direction of the main axis 3.

FIG. 5 shows a further modification of the isolating gap within the switch-disconnector housing 2. The movable isolating contact 30 is in the form of a bolt which can be moved along the bolt longitudinal axis, at an angle to the main axis 3. A rocker 31 is provided for this purpose, and is mounted such that it can pivot. The movable isolating contact 30 may in this case be moved beyond its switched-off position during the course of a switching-off movement, with its end facing away from the isolating gap being inserted into a mating contact on the switch-disconnector housing 2. This insertion into the mating contact allows the second electrical phase conductor 8 to be grounded.

FIG. 6 shows a further variant of an isolating gap. A movable isolating contact 40 is mounted on the second electrical phase conductor 8. This movable isolating contact 40 is in the form of a blade which can pivot and, in its neutral position, is covered by shielding shrouds which make contact with the second electrical phase conductor 8. When the isolating gap is closed, the movable isolating contact 40 is inserted into a mating contact 41 which is in the form of a slot and makes contact with a second electrical phase conductor 9. During a switching-off process of the movable isolating contact 40, this contact 40 is pivoted out of the mating contact 41 and can be inserted via its neutral position into a mating contact which is electrically conductively connected to the switch-disconnector housing 2. This mating contact allows the second electrical phase conductor 8 to have a ground potential applied to it.

Details of the individual embodiment variants can be combined with one another thus making it possible to create different embodiment variants which are not illustrated in FIGS. 1 to 6.

1-11. (canceled)

12. A compressed-gas-insulated switch-disconnector module, comprising:
an electrically conductive housing having first and second flanges;
a main axis;
first and second electrical phase conductors extended along said main axis for connection at an isolating gap;
said first phase conductor passing through said first flange;
said second phase conductor passing through said second flange; and
a tubular electrode connected to said housing, concentrically surrounding said first phase conductor, disposed radially inside said first flange, and projecting beyond said first flange.

13. The compressed-gas-insulated switch-disconnector module according to claim 12, wherein said first and second flanges are mutually coaxial and disposed at mutually opposite ends of said housing, and said second flange as an outside with a holding device for receiving a toroidal transformer.

14. The compressed-gas-insulated switch-disconnector module according to claim 13, which further comprises a tubular connecting stub at least partially supporting said transformer, said second flange being disposed at an end of said tubular connecting stub.

15. The compressed-gas-insulated switch-disconnector module according to claim 12, wherein said first and second flanges are annular, and said first flange has a larger circumference than said second flange.

16. The compressed-gas-insulated switch-disconnector module according to claim 12, wherein said electrode is supported by said housing.

17. The compressed-gas-insulated switch-disconnector module according to claim 16, wherein said electrode is cast onto said housing.

18. The compressed-gas-insulated switch-disconnector module according to claim 12, which further comprises a grounding switch disposed in an interior of said housing for grounding one of said phase conductors.

19. A bushing configuration, comprising:
an electrically conductive housing;
a switch disconnector having an isolating gap insulated by compressed gas within said housing, said isolating gap having a switching contact;
an electrically insulating casing flange-connected to said housing as an outdoor bushing;
a (first) phase conductor passing through said casing and having one end connected to said switching contact; and
said housing and said casing surrounding a common gas area.

20. The bushing configuration according to claim 19, which further comprises a pillar support supporting said (first) phase conductor on said housing.

21. The bushing configuration according to claim 20, wherein said pillar support supports said (first) phase conductor through said switching contact.

22. The bushing configuration according to claim 19, wherein said housing has a tubular connecting stub, said gas area extends into said tubular connecting stub, and a toroidal transformer is disposed around said tubular connecting stub.

23. The bushing configuration according to claim 19, wherein said insulating casing and said housing define a connecting area therebetween, and an electrode extends coaxially relative to said (first) phase conductor and shields said connecting area.
